(19) United States
(12) Patent Application Publication
(10) Pub. No.: US 2026/0000965 A1
(43) Pub. Date: Jan. 1, 2026

(54) Strategy board game wherein game pieces occupy three spaces at once by casting shadows

(71) Applicant: Scott Lewis Becker, Deerfield, IL (US)

(72) Inventor: Scott Lewis Becker, Deerfield, IL (US)

(21) Appl. No.: 18/757,827

(22) Filed: Jun. 28, 2024

(51) Int. Cl. A63F 3/00; A63F 13/80

(52) U.S. Cl. CPC A63F 3/00643; A63F 13/80; A63F 2003/00182; A63F 2003/00523; A63F 2003/00646

(57) ABSTRACT

A tactical strategy board game is disclosed. Three side boards are affixed to a central board at a set upright angle with respect to the flat, horizontal play surface. Each of the three side boards has a directional lighting apparatus aimed perpendicularly towards it from opposite the central board. Game pieces are placed on the central board between the directional lighting apparatus and the side boards. These game pieces are shaped such that they cast a different shadow silhouette onto each of the three side boards. Each of these shadows is given distinct game rules.

### BACKGROUND OF THE INVENTION

It is known that strategic games featuring pieces moving between or being placed upon demarcated spaces on a board, such as Chess and Go, have been played for many hundreds of years as a recreational activity. These board games are typically designed to be enjoyed by a minimum of two players. The present invention is one such strategic board game.

### SUMMARY OF THE INVENTION

The present invention is a combination of game boards, directional lighting apparatus, and precisely-shaped playing pieces which facilitate strategic gameplay when integrated. These elements shall be summarized in the preceding order.

Four game boards are used in the present invention. One of these is a central board to which the remaining three side boards are affixed in a set position before the game begins. These side boards are affixed to the central board at equidistant points, such that they are all equally far apart. The far edge of each side board which is not affixed to the central board is elevated, forming an angle between 90 and 180 degrees with respect to the central board and between 0 and 90 degrees with respect to the surface upon which the central board is placed. Each of the side boards features an arrangement of demarcated spaces as is typical for strategy board games. The central board features an arrangement of polygonal slots deeper than they are wide into which objects of the matching polygonal shape may be inserted. The central board may or may not have demarcated spaces surrounding each of these slots.

Directional lighting apparatus comprised of a light source and a stand are also employed, henceforth known as spotlights. Each spotlight is identical, and neither their height nor angle may be adjusted, though they may disassemble, fold, or otherwise become compact in size when not in use. The spotlights are constructed such that when they are turned on, their glow illuminates each of the side boards at an angle normal to their respective board. The present invention includes three such spotlights.

Multiple playing pieces are used in the present invention. These pieces are irregularly shaped, such that it is only possible to intuit what each piece represents when they are viewed from one of three specific angles. Each angle produces a distinctly shaped silhouette. Placing each piece in a standard three-dimensional Euclidian space with one of these angles aligned to the XY plane, the other two angles then become aligned to the XZ and YZ planes. One can thus imagine each piece as a cube with cuts carved out of it such that the silhouette of each parallel pair of sides contracts from a square outline into three different, more complex forms. Continuing from the same Euclidian space, take the corner of the unaltered cube and place it at the origin: (0,0,0). The playing pieces each incorporate a keyed shaft extending diagonally along the line running through the origin and the opposite corner of the playing piece. This keyed shaft is cut in the same polygonal shape as the slots on the central board. When reoriented downwards and aligned, these shafts may be inserted into any of those slots on the central board. In this manner the pieces remain upright and in place on the board, unable to shift or rotate until they are removed. The keyed shaft is multiple times longer in length than the main body of the playing piece, thus ensuring the resulting shadow falls upon all three side boards when the piece is placed in the intended slots.

When these three elements are assembled into the present invention and the light sources are turned on, any playing piece placed on the central board will then cast three distinct shadows in three directions, able to occupy a space on each of the three side boards at the same time with a distinct silhouette appearing on each. Rotating the pieces 120 degrees about their shafts will keep these cast shadows in the same spaces, but alter their shapes in accordance with the direction of rotation.

Board games exist which involve the casting of differently shaped shadows in gameplay [1]. Other board games exist which involve multiple game boards affixed to each other in positions not flush with the flat play surface [2]. However, no board game exists which employs game pieces shaped in such a manner that each piece casts different shadow silhouette in multiple locations simultaneously when placed in the overlapping paths of multiple directional light sources. Thus, the present invention provides a unique and novel form of entertainment.

### DESCRIPTION OF THE DRAWINGS

FIG. 1 depicts the game board. FIG. 1A shows the game board as viewed from above. FIG. 1B shows the game board as viewed from the side. Item 1 is a spotlight, three of which are shown. Two of spotlights are only shown in part, but all three are identical. Item 2 is a side board with elliptical spaces, three of which are shown. Item 3 is a clip, for affixing the side board to the central board, six of which are shown. Item 4 is the central board. Each edge of the central board measures 33 centimeters in length. This measurement is provided solely to evoke the scale of the objects and is variable. Item 5 is a playing piece. Item 6 is the keyed shaft extending from Item 5. The hatched areas of the Figure represent the shadows which are cast from Items 5 and 6 when the light sources are turned on. For clarity, only one playing piece is depicted in the Figure.

FIG. 2 depicts the playing piece from FIG. 1, Item 5, at a larger scale and viewed parallel to the three planes of Euclidian space as previously discussed in the summary of the invention. FIG. 2A shows the playing piece when viewed from the XY plane. The silhouette formed by the playing piece when viewed from this plane is that of a monster. FIG. 2B shows the playing piece when viewed from the XZ plane. The silhouette formed by the playing piece when viewed from this plane is that of a horse's head. FIG. 2C shows the playing piece when viewed from the YZ plane. The silhouette formed by the playing piece when viewed from this plane is that of a soldier's head.

### DESCRIPTION OF A PREFERRED EMBODIMENT

In the preferred embodiment, the central board is in the shape of an equilateral triangle. When the board's slots are equally spaced apart, this maximizes the number of slots pieces may occupy such that all three of their shadows fall upon the side boards, as opposed to the central board or the play surface. This yields two benefits. The first is that it allows for the side boards, piece shafts, and light sources to all be smaller in overall size. This makes it easier for players to find a surface large enough to play on, as well as reducing the hassle of transporting the components of the preferred embodiment. The second benefit is that one face of a piece may be removed from one of the side boards at a time if it is positioned near a corner of the central board, allowing for more strategic depth in gameplay. The central board's slots and the pieces' keyed shafts are also equilateral triangles in the preferred embodiment, to prevent pieces from being rotated at an angle whereas no recognizable silhouette is visible in its shadows.

The central board in this embodiment is half a centimeter in thickness, and cut from wood or plastic. The side boards are made of a traditional binding board or chipboard material, and are affixed to the central board with clips which hold them at a 35.25 degree angle. The side boards are rectangular or trapezoidal in shape.

The light sources in this embodiment are LED flashlights of sufficient brightness mounted on collapsible stands such that they may be removed and replaced. A plastic clip is used for mounting the flashlights in this embodiment. The stands are 59 centimeters high when unfolded. The base of each collapsible stand can also slot into a corner of the central board or otherwise be aligned to said corners through markings. This ensures the light sources are centered above each side board, in addition to the light being projected from their set angle. Each stand is constructed from metal or plastic using conventional methods.

In this preferred embodiment, there are multiple types of playing pieces. The piece's type is distinguishable by its color or shade, whereas the color or shade of that piece's shaft denotes which player controls it. The pieces are to be manufactured via additive manufacturing as defined in CPC subclass B33Y, since their shapes are too complex for other methods such as milling or injection molding to be feasible at a reasonable cost. Further preferable is the selective laser sintering of a polymer powder or resin, as these methods avoid the layer lines which would be visible if filament deposition was used.

Playing pieces are set up on the board in the same starting arrangement at the beginning of each game. Play proceeds in alternating turns. During each of their turns, the player whose turn it is chooses one of their pieces to use. They may move it once, rotate it once, and capture with it once, in any order. Then the next player takes their turn. Pieces move one slot at a time, and only to an adjacent slot on the board. Pieces capture based on the position and shape of the shadow face shown in the spaces on each of the side boards. If one face a piece casts is captured, the entire piece is captured and removed from the center board. Pieces do not move when capturing, and capture based on the Range of the face shown. Faces must be the exact Range away from another face to capture the piece casting that face onto a side board. Range one is adjacent. Each additional slot of distance away on the central board increments the Range between pieces by one. Faces can't capture faces with the same Range. Pieces on the two rows of the center board furthest from each side board will not have their face fully falling onto that side board. Those faces are treated as not being present on any board. Faces can only capture pieces on the same side board.

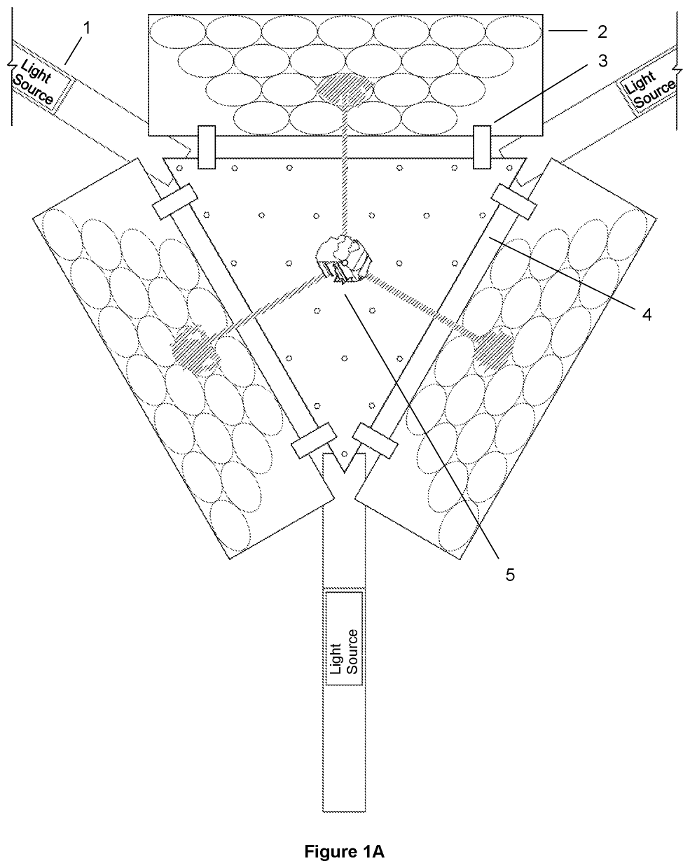

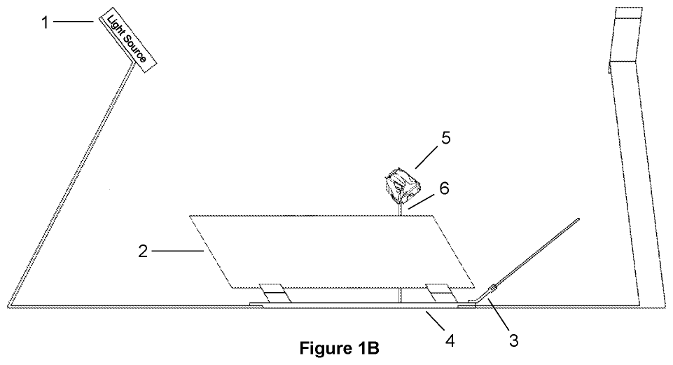

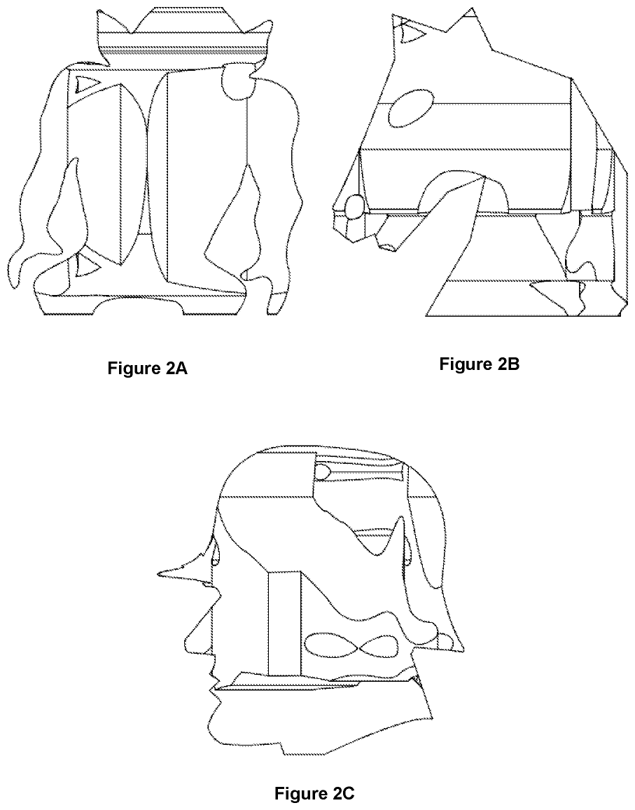

There are three types of playing pieces, described as follows. The first of these is the Infantry piece, as depicted in FIGS. 1 and 2. Its three faces are the Monster, the Soldier, and the Horse. The Monster has a Range of one. The Solider has a Range of two. The Horse cannot be captured. Instead of capturing, it may switch positions with an adjacent piece belonging to either player if that piece has a visible face on the same board. Neither piece is rotated when this is done. Each player begins the game with three Infantry pieces. The second type of playing piece is the Vehicle. Its three faces are the Tank, the Flying Saucer, and the Boat. The Tank has a Range of one. The Flying Saucer has a Range of two. The Boat cannot be captured. Instead of capturing, it may cloak the board it's on. To do this, turn the light currently casting the Boat face off. If another of the lights is off, turn that light back on. Each player begins the game with three Vehicle pieces. If all three of both players' Vehicle pieces are captured and the game isn't over, turn all lights back on.

The last type of piece is the Shadow Lord. Each player begins the game with one Shadow Lord. It has a Range of three and is constructed from a flat section of paperboard, plastic, or metal. Unlike the other types of playing piece, it therefore can only cast a shadow in one direction at a time and will only ever occupy a space on one side board at a time. The first player to capture six of their opponent's pieces wins the game.

### Description of Alternative Embodiments

Possible alternative embodiments for the construction of this strategic board game include embodiments which use a hexagonal central board instead of a triangular central board. The shadow silhouette shapes produced by each playing piece when light falls upon them are subject to variation from those listed in the preferred embodiment. The board game may have components which vary in overall size from the preferred embodiment. The central and side boards may instead be permanently affixed in alternative embodiments, omitting the clips in favor of hinges. The spotlights may be unable to fold up and collapse in alternative embodiments. They may also have the light source built into the apparatus, unable to be removed, and may also be affixed to the central board. The playing pieces may have a traditional flat base in lieu of a keyed shaft, and the central board may in turn lack slots. These alternative embodiments may be considered if the cost of manufacturing the preferred embodiment proves excessive. Different manufacturing methods and materials may also be considered.

Possible alternative embodiments for the game rules of this strategic board game include versions playable alone or with more than two players. The starting configuration, quantity, and number of types of playing pieces are subject to variation. Other game rules, including the means by which a player may win the game, are also subject to variation.

1. A board game to be played by one or more persons, said board game comprising:
a) A plurality of movable playing pieces whereas three distinctly-shaped shadows may be cast from each individual playing piece depending upon the angle to which said playing piece is rotated with respect to a directional lighting apparatus;
b) Three directional lighting apparatus arranged such that a plurality of said distinctly shaped shadows may be cast simultaneously from each individual playing piece;
c) A plurality of game boards having a plurality of spaces upon which these cast shadows may fall.

2. An interactive electronic software, website, or application comprising a digital version of the board game outlined in claim 1, playable on a computer or other device with an electronic display screen alone against an artificial opponent controlled by the computer or with one or more other players, whereas all elements of the board game are instead incorporated into the electronic display screen.
